(19) United States
(12) Patent Application Publication
(10) Pub. No.: US 2009/0251105 A1
(43) Pub. Date: Oct. 8, 2009

(54) TEMPERATURE CONTROLLER

(75) Inventors: Hu Peng, Beijing (CN); Haiqing Li, Beijing (CN)

Correspondence Address: WOLF GREENFIELD & SACKS, P.C., 600 ATLANTIC AVENUE, BOSTON, MA, 02210-2206, US

(73) Assignee: Beijing HaiLin Auto Control Equipment Co., Ltd., Beijing (CN)

(21) Appl. No.: 12/203,150

(22) Filed: Sep. 3, 2008

(30) Foreign Application Priority Data
Apr. 2, 2008 (CN) CN 200810103310.0

(51) Int. Cl. H02J 7/00

(52) U.S. Cl. 320/135

(57) ABSTRACT

A temperature controller is disclosed in the invention, and the temperature controller includes one dry battery, a voltage conversion circuit connected with outputs of the battery and a temperature controller control circuit connected with the voltage conversion circuit. The voltage conversion circuit provides a power supply for the temperature controller control circuit. The temperature controller in the invention requires only one battery as the power supply, so that energies are saved, and the temperature controller is reduced in size and can be mounted more easily.

This application claims priority of Chinese Patent Application No. 200810103310.0 filed on Apr. 2, 2008 and entitled “Temperature Controller”, which is hereby incorporated by reference in its entirety.

### FIELD OF THE INVENTION

The present invention relates to a temperature control apparatus for Heating Ventilation and Air Conditioning, and particularly to a temperature controller.

### BACKGROUND OF THE INVENTION

Temperature controllers are deployed in Heating Ventilation and Air Conditioning (HVAC) applications, for example a central air conditioner in a building or villa, a household central air conditioner, etc., and are common temperature control apparatus for the Heating Ventilation and Air Conditioning.

A temperature controller may be applied in every house, or even in every room. A desired temperature value is set for each house. The temperature controller compares the actual air supply temperature of the air conditioner and the set temperature, and controls the turning on or off of the air conditioner to adjust the temperature.

With reference to FIG. 1, a diagram illustrating a structure of a temperature controller in the prior art is shown. The existing temperature controller is mostly a battery-powered temperature controller, or a temperature controller using a battery as a backup power supply. These existing temperature controllers each require two AA batteries 11 to provide a power supply for a temperature controller control circuit 12.

However, the batteries are not reusable energies and are polluting products. Two batteries are required for each temperature controller, as a result, energies are wasted, and the environment may be polluted if the batteries are not recycled properly.

Therefore, a problem to be addressed in the art is to provide a temperature controller without the above drawbacks.

### SUMMARY OF THE INVENTION

In view of the above drawbacks, an aspect of the present invention is to provide a temperature controller which requires only one battery as a power supply, so that energies are saved.

The temperature controller provided in the present invention includes one dry battery, a voltage conversion circuit connected with outputs of the battery and a temperature controller control circuit connected with the voltage conversion circuit. The voltage conversion circuit is adapted to provide a power supply for the temperature controller control circuit.

Preferably, the voltage conversion circuit is adapted to convert an output voltage of the battery into a voltage value applicable to the temperature controller control circuit.

Preferable, the battery is an alkaline battery or a rechargeable battery, and has an output voltage within a range of 1.2V-5.5V.

Preferably, the temperature controller further includes a display unit, which is connected with both the temperature controller control circuit and the voltage conversion circuit and is adapted to display the operation status of the temperature controller.

Preferably, the voltage conversion circuit is a DC/DC boost regulator.

Preferably, the voltage conversion circuit further includes a voltage regulator circuit connected in serial with the DC/DC boost regulator.

Preferably, the voltage conversion circuit includes a capacitor connected in parallel with the battery, and an inductor for energy storing and a diode which are connected in serial between an anode of the battery and a voltage output of the voltage conversion circuit.

Preferably, the temperature controller control circuit includes a relay switch adapted to control an air conditioner connected with the temperature controller.

Preferably, the temperature controller control circuit includes a relay switch, which is connected in serial with the voltage conversion circuit 2 and adapted to control an air conditioner connected with the temperature controller.

In the temperature controller according to an embodiment of the present invention, a voltage conversion circuit is provided to convert a voltage of the one dry battery into a voltage required for normal operation of the temperature controller, so that one dry battery is saved every temperature controller, thereby saving energies, as well as a usage cost. A battery box of the temperature controller needs simply to be designed to hold one battery only, thus the temperature controller is reduced in size and can be mounted more easily.

### BRIEF DESCRIPTION OF THE DRAWINGS

FIG. 1 is a diagram illustrating a structure of the temperature controller in the prior art;

FIG. 2 is a diagram illustrating a structure of the temperature controller according to a first embodiment of the present invention;

FIG. 3 is a diagram illustrating a structure of the temperature controller according to a second embodiment of the present invention;

FIG. 4 is a diagram illustrating a structure of the temperature controller according to a third embodiment of the present invention;

FIG. 5 is a schematic diagram of a DC/DC boost regulator as shown in FIG. 4;

FIG. 6 is a diagram illustrating a structure of the temperature controller according to a fourth embodiment of the present invention; and

FIG. 7 is an illustrative circuit diagram of the temperature controller according to an embodiment of the present invention.

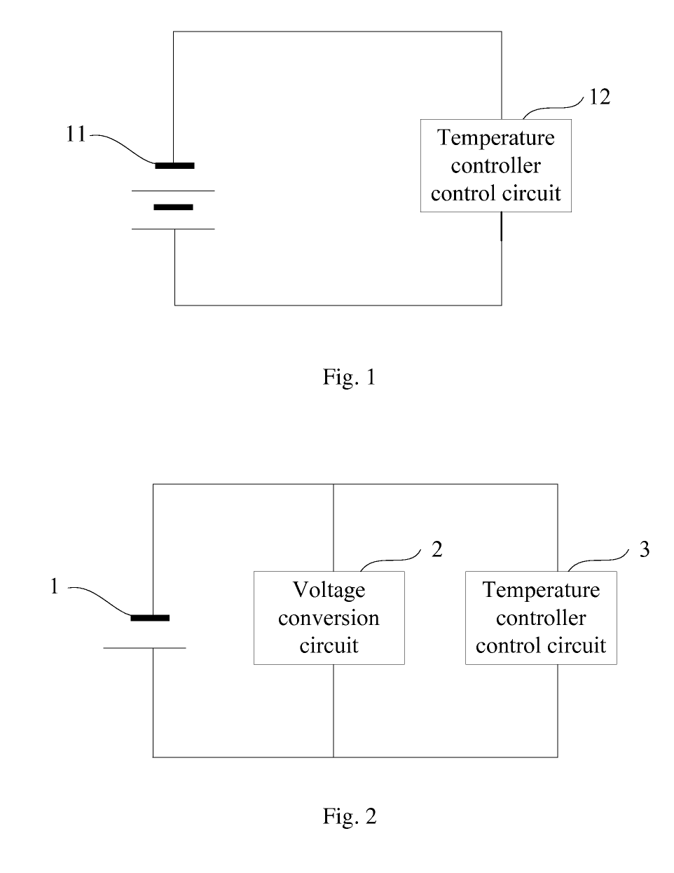

### DETAILED DESCRIPTION OF THE INVENTION

An aspect of the invention is to provide a temperature controller, which requires only one battery as a power supply, so that energies are saved.

With reference to FIG. 2, a diagram illustrating the structure of the temperature controller according to a first embodiment of the present invention is shown.

The temperature controller according to the embodiment is mostly used as a battery-powered temperature controller.

The temperature controller according to the first embodiment of the present invention includes one dry battery 1, a voltage conversion circuit 2 connected with outputs of the battery 1 and a temperature controller control circuit 3 connected with the voltage conversion circuit 2. The voltage conversion circuit 2 is adapted to provide a power supply for the temperature controller control circuit 3.

The voltage conversion circuit 2 is adapted to convert an output voltage of the battery 1 into a voltage value applicable to the temperature controller control circuit 3.

Particularly, the battery 1 is an alkaline battery or a rechargeable battery, and has an output voltage within a range of 1.2V-5.5V. Typically, the battery 1 may be an AA dry battery.

In the temperature controller according to the embodiment of the present invention, a voltage conversion circuit 2 is provided to convert a voltage of one dry battery 1 into a voltage required for normal operation of the temperature controller control circuit 3, so that one dry battery is saved every temperature controller, thereby saving energies, as well as a usage cost. A battery box of the temperature controller needs simply to be designed to hold one battery only, thus the temperature controller is reduced in size and can be mounted more easily.

To facilitate the usage of the temperature controller, a display unit is added to the temperature controller according to the second embodiment of the present invention.

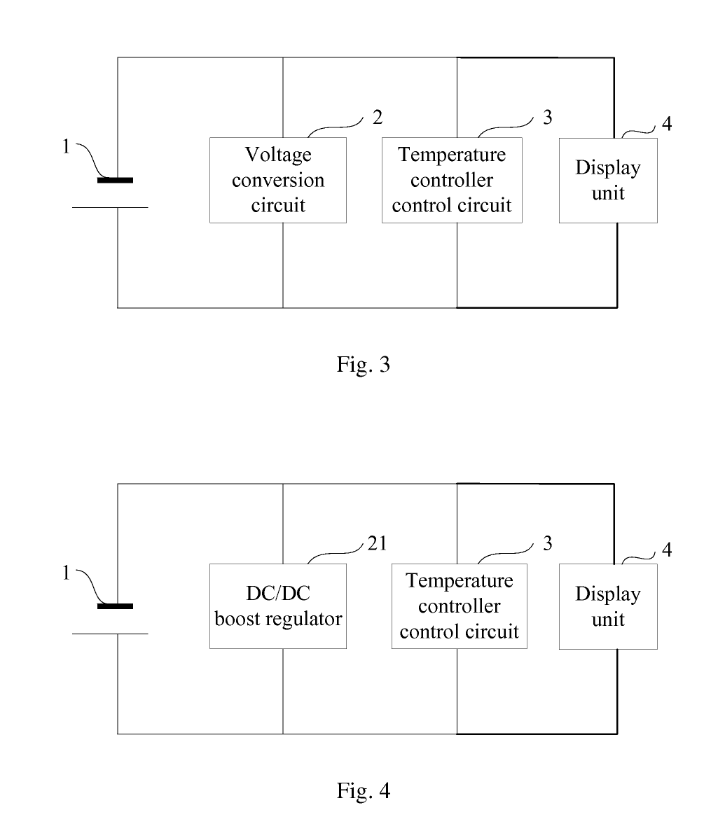

With reference to FIG. 3, a diagram illustrating a structure of the temperature controller according to the second embodiment of the present invention is shown.

In comparison with the temperature controller according to the first embodiment, the temperature controller according to the second embodiment further includes a display unit connected with both the temperature controller control circuit and the voltage conversion circuit.

The temperature controller according to the second embodiment includes one dry battery 1, a voltage conversion circuit 2 connected with outputs of the battery 1, a temperature controller control circuit 3 connected with the voltage conversion circuit 2 and a display unit 4 connected with both the temperature controller control circuit 3 and the voltage conversion circuit 2. The voltage conversion circuit 2 is adapted to provide a voltage required for the temperature controller control circuit 3.

The voltage conversion circuit 2 converts an output voltage of the battery 1 into a voltage value applicable to the temperature controller control circuit 3.

Particularly, the battery 1 is an alkaline battery or a rechargeable battery and has an output voltage within a range of 1.2V-5.5V. Typically, the battery 1 may be an AA dry battery.

The display unit 4 is adapted to display the operation status of the temperature controller. The display screen of the display unit 4 may be selected dependent upon requirements. Particularly, the display screen may be a Liquid Crystal Display screen.

In the temperature controller according to the second embodiment, the operation status of the temperature controller, such as parameter values including the set temperature, the current temperature and the like, may be displayed with the use of the display unit 4.

Likewise, in the temperature controller according to the second embodiment, a voltage conversion circuit 2 is provided to convert the voltage of the one dry battery 1 into a voltage required for normal operation of the temperature controller control circuit 3, so that one dry battery is saved every temperature controller, thereby saving energies, as well as a usage cost. The battery box of the temperature controller needs simply to be designed to hold one battery only, thus the temperature controller is reduced in size and can be mounted more easily.

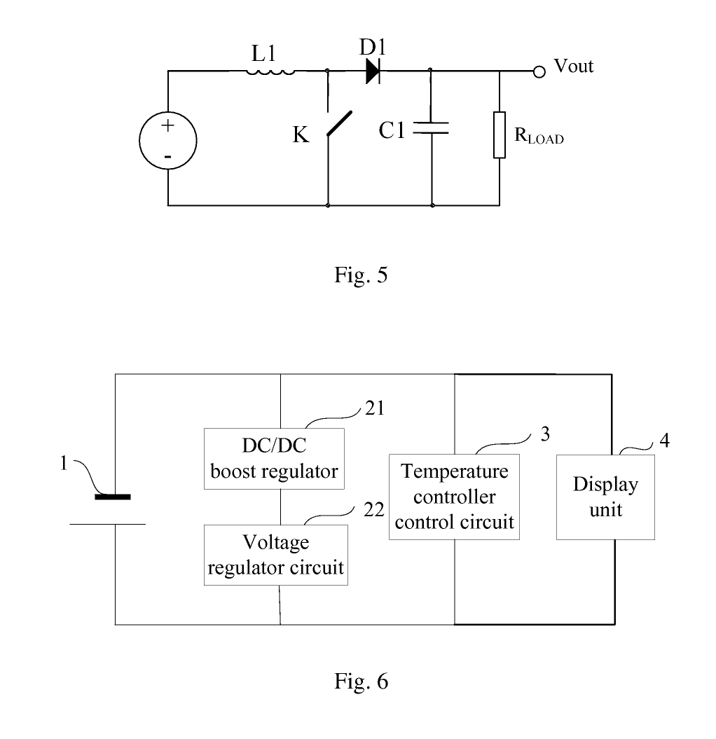

With reference to FIGS. 4 and 5, a diagram illustrating a structure of the temperature controller according to the third embodiment of the present invention is shown in FIG. 4, and a schematic diagram of a DC/DC boost regulator as shown in FIG. 4 is shown in FIG. 5.

In comparison with the temperature controllers according to the first and second embodiments, the temperature controller according to the third embodiment includes a voltage conversion circuit 2 including a DC/DC boost regulator 21.

As shown in FIG. 5, the DC/DC boost regulator 21 per se has a load R_{LOAD}. When a switch K is turned on, energies are stored in an inductor L1 and a capacitor C1. The current flowing in the inductor L1 can not change instantaneously, instead, the current increases linearly, and charges the capacitor C1.

When the switch K is turned off, the current flowing in the load R_{LOAD} is provided by the inductor L1 and the capacitor C1. Due to the current limiting of the diode D1, the voltage across the capacitor C1 is higher than that provided by the power supply, thus the voltage across the load R_{LOAD} is increased.

The temperature controller according to the third embodiment includes one dry battery 1, a voltage conversion circuit 2 connected with outputs of the battery 1 and a temperature controller control circuit 3 connected with the voltage conversion circuit 2. The voltage conversion circuit 2 is adapted to provide a voltage required for the temperature controller control circuit 3.

Particularly, the voltage conversion circuit 2 converts an output voltage of the battery 1 into a voltage value applicable to the temperature controller control circuit 3 using the DC/DC boost regulator 21.

Particularly, the battery 1 may be an alkaline battery or a rechargeable battery and have an output voltage within a range of 1.2V-5.5V. Typically, the battery 1 may be an AA dry battery.

L1kewise, in the temperature controller according to the third embodiment, the DC/DC boost regulator 21 is provided to convert the voltage of the one dry battery 1 into the voltage required for normal operation of the temperature controller control circuit 3, so that one dry battery is saved every temperature controller, thereby saving energies, as well as a usage cost. The battery box of the temperature controller needs simply to be designed to hold one battery only, thus the temperature controller is reduced in size and can be mounted more easily.

With reference to FIG. 6, a diagram illustrating a structure of the temperature controller according to the fourth embodiment of the present invention is shown.

In comparison with the temperature controller according to the third embodiment, the temperature controller according to the fourth embodiment further includes a voltage regulator circuit 22 connected in serial with a DC/DC boost regulator 21.

The temperature controller according to the fourth embodiment includes one dry battery 1, a voltage conversion circuit 2 connected with outputs of the battery 1, a temperature controller control circuit 3 connected with the voltage conversion circuit 2, and a voltage regulator circuit 22 connected with the DC/DC boost regulator 21. The DC/DC boost regulator 21 and the voltage regulator circuit 22 are adapted to provide a voltage required for the temperature controller control circuit 3.

The DC/DC boost regulator 21 and the voltage regulator circuit 22 provide a stabilized voltage value required for the temperature controller control circuit 3.

The DC/DC boost regulator 21 is adapted to convert an output voltage of the battery 1 into a voltage value applicable to the temperature controller control circuit 3.

The voltage regulator circuit 22 is connected in serial with the DC/DC boost regulator 21 to ensure a stable output of the voltage converted by the DC/DC boost regulator 21.

Particularly, the battery 1 may be an alkaline battery or a rechargeable battery and have an output voltage within a range of 1.2V-5.5V. Typically, the battery 1 may be an AA dry battery.

Particularly, the voltage regulator circuit 22 may implement the voltage regulation using loads such as an inductor and a resistor.

In the temperature controller according to the fourth embodiment, the DC/DC boost regulator 21 is provided to convert the voltage of the one dry battery 1 into the voltage required for normal operation of the temperature controller control circuit 3, and the voltage regulator circuit 22 connected in serial with the DC/DC boost regulator 21 is further included to ensure the stable output of the voltage converted by the DC/DC boost regulator 21, thus the DC/DC boost regulator 21 and the voltage regulator circuit 22 can provide a stabilized voltage required for the temperature controller control circuit 3. As a result, one dry battery is saved every temperature controller, thereby saving energies, as well as a usage cost. The battery box of the temperature controller needs simply to be designed to hold one battery only, thus the temperature controller is reduced in size and can be mounted more easily.

Particularly, a chip SP6641B may be used to implement the DC/DC boost regulator 21 and the voltage regulator circuit 22 connected in serial for voltage conversion.

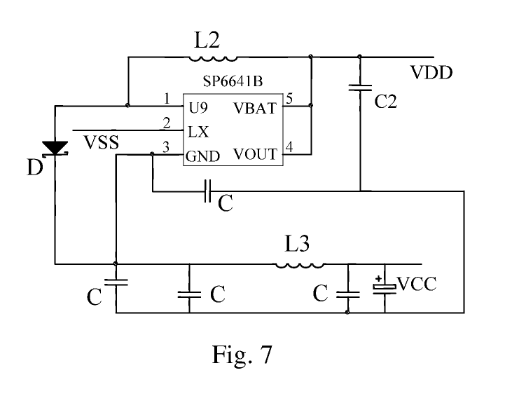

With reference to FIG. 7, an illustrative circuit diagram of the temperature controller according to the embodiment of the present invention is shown.

The voltage conversion circuit 2 includes a chip SP6641B, a capacitor C connected in parallel with a battery 1, and an inductor L3 for energy storing and a diode D which are connected in serial between an anode of the battery 1 and a voltage output of the voltage conversion circuit 2.

If the voltage conversion circuit 2 per se has a load R_{LOAD}, when a switch K is turned on, energies are stored in the inductor L3 and the capacitor C. The current flowing in the inductor L3 can not change instantaneously, instead, the current increases linearly, and charges the capacitor C.

When the switch K is turned off, the current flowing in the load R_{LOAD} is provided by the inductor L3 and the capacitor C. Due to the current limiting of the diode D, the voltage across the capacitor C is higher than the voltage provided by the power supply, thus the voltage across the load R_{LOAD} is increased.

In the embodiment, due to that the capacitor C connected in parallel with the battery 1, and the inductor L3 for energy storing and the diode D which are connected in serial between the anode of the battery 1 and the voltage output of the voltage conversion circuit 2 are provided in the temperature controller, the voltage of the one dry battery 1 may be converted into a voltage required for normal operation of the temperature controller control circuit 3, so that one dry battery is saved every temperature controller, thereby saving energies, as well as a usage cost.

The temperature controller control circuit may further include a relay switch connected in serial with the voltage conversion circuit 2 to control the air conditioner connected with the temperature controller.

The relay is an electronic control device, includes a controlling system (also referred to as an input loop) and a controlled system (also referred to as an output loop), and is typically applied in an automatic control circuit. Actually, the relay is an “automatic switch” which controls a higher current using a lower current, and therefore has functions of automatic regulation, security and protection, circuit converting, etc.

The temperature controllers in the embodiments are mostly used as battery-powered temperature controllers, or temperature controller products using a battery as a backup power supply. In particular, the temperature controllers in the embodiments may be deployed in the fields of an air conditioner, a hanging boiler, fresh air, etc.

The preferred embodiments of the invention are described above. It will be appreciated that various improvements and modifications can be made to the invention without departing from the scope thereof by the ordinary skilled in the art, and all these improvements and modifications are intended to fall within the scope of the invention.

1. A temperature controller, comprising one dry battery, a voltage conversion circuit connected with outputs of the battery and a temperature controller control circuit connected with the voltage conversion circuit, wherein the voltage conversion circuit is adapted to provide a power supply for the temperature controller control circuit.

2. The temperature controller of claim 1, wherein the voltage conversion circuit is adapted to convert an output voltage of the battery into a voltage value applicable to the temperature controller control circuit.

3. The temperature controller of claim 2, wherein the battery is an alkaline battery or a rechargeable battery, and has an output voltage within a range of 1.2V-5.5V.

4. The temperature controller of claim 1, further comprising a display unit, which is connected with both the temperature controller control circuit and the voltage conversion circuit and is adapted to display operation status of the temperature controller.

5. The temperature controller of claim 1, wherein the voltage conversion circuit is a DC/DC boost regulator.

6. The temperature controller of claim 5, wherein the voltage conversion circuit further comprises a voltage regulator circuit connected in serial with the DC/DC boost regulator.

7. The temperature controller of 1, wherein the voltage conversion circuit comprises a capacitor connected in parallel with the battery, and an inductor for energy storing and a diode which are connected in serial between an anode of the battery and a voltage output of the voltage conversion circuit.

8. The temperature controller of claim 7, wherein the temperature controller control circuit comprises a relay switch adapted to control an air conditioner connected with the temperature controller.

9. The temperature controller of claim 1, wherein the temperature controller control circuit comprises a relay switch, which is connected in serial with the voltage conversion circuit 2 and is adapted to control an air conditioner connected with the temperature controller.
